(19) United States
(12) Patent Application Publication
(10) Pub. No.: US 2025/0327552 A1
(43) Pub. Date: Oct. 23, 2025

(54) ELECTRONIC CANDLE

(71) Applicant: Dongguan Shuiquanzi Industrial Co., Ltd., Dongguan (CN)

(72) Inventor: Huilin She, Dongguan (CN)

(21) Appl. No.: 19/257,563

(22) Filed: Jul. 2, 2025

Related U.S. Application Data
(63) Continuation-in-part of application No. 19/236,990, filed on Jun. 13, 2025.
Application No. 19/236,990 is a continuation-in-part of application No. 18/790,422, filed on Jul. 31, 2024, now Pat. No. 12,392,464.
(63) Continuation-in-part of application No. 19/240,075, filed on Jun. 17, 2025.
Application No. 19/240,075 is a continuation-in-part of application No. 18/790,422, filed on Jul. 31, 2024, now Pat. No. 12,392,464.

(30) Foreign Application Priority Data
Aug. 4, 2023 (CN) 202310978490.1
Aug. 4, 2023 (CN) 202322091015.0
Apr. 25, 2025 (CN) 202520813186.6
May 7, 2025 (CN) 202520891352.4
May 22, 2025 (CN) 202521031273.2
May 28, 2025 (CN) 202521076739.0

(51) Int. Cl. F21S 10/04; F21S 9/02; F21V 31/00

(52) U.S. Cl. CPC F21S 10/04; F21S 9/02; F21V 31/005

(57) ABSTRACT

An electronic candle, including an inner housing, a light element disposed on the inner housing, a candle tube sleeved outside the inner housing and an electronic assembly, the candle tube is light-transmissive and non-transparent, the lighting element emits light that passes through the candle tube; and the electronic assembly includes a printed circuit board assembly (PCBA) and a lamp head, at least a portion of the PCBA is arranged within the inner housing, the PCBA is electrically connected to both the light element and the lamp head, and the lamp head extends through the candle tube.

### CROSS REFERENCE TO RELATED APPLICATIONS

The present application claims the priority of Chinese patent application No. 202521076739.0, filed on May 28, 2025; Chinese patent application No. 202520813186.6, filed on Apr. 25, 2025; Chinese patent application No. 202310978490.1, filed on Aug. 4, 2023; Chinese patent application No. 202322091015.0, filed on Aug. 4, 2023; Chinese patent application No. 202520891352.4, filed on May 7, 2025; Chinese patent application No. 202521031273.2, filed on May 22, 2025, contents of which are incorporated herein by its entireties.

This application is a continuation-in-part application of the U.S. patent application Ser. No. 19/236,990 filed on Jun. 13, 2025, which is a continuation-in-part application of the U.S. patent application Ser. No. 18/790,422 filed on Jul. 31, 2024; and this application is a continuation-in-part application of the U.S. patent application Ser. No. 19/240,075 filed on Jun. 17, 2025, which is a continuation-in-part application of the U.S. patent application Ser. No. 18/790,422, filed on Jul. 31, 2024, contents of which are incorporated herein by its entireties.

### FIELD

The present disclosure relates to the field of candles, and particularly to an electronic candle.

### BACKGROUND

Electronic candles have the advantages of being smokeless, safe, and durable, and are widely used as substitutes for traditional candles in various scenarios. In conventional electronic candles, a light string is typically wound around an outer surface of a candle tube, and wires of the light string are exposed outside, which compromises aesthetics and results in a relatively small illuminated area when the light string is lit.

Therefore, improvements to existing electronic candles are needed to address the above deficiencies.

### SUMMARY

An electronic candle, including an inner housing, a light element disposed on the inner housing, a candle tube sleeved outside the inner housing and an electronic assembly, the candle tube is light-transmissive and non-transparent, the lighting element emits light that passes through the candle tube; and the electronic assembly includes a printed circuit board assembly (PCBA) and a lamp head, at least a portion of the PCBA is arranged within the inner housing, the PCBA is electrically connected to both the light element and the lamp head, and the lamp head extends through the candle tube.

Based on the above description, the light element is disposed on the inner housing, and the candle tube which is light-transmitting but non-transparent is sleeved on the outside of the inner housing. When the light element is not illuminated, the light element is not visible from outside the candle tube. When the light element is illuminated, light emitted by the light element penetrates the candle tube and forms an illumination zone on the candle tube, at this time, only the brightness is visible to a user, which improves a aesthetic of the electronic candle. In addition, light emitted by the light element can be transmitted and diffused through the candle tube to increase the area of the illumination zone, generating a hazy and soft visual effect.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is a structural schematic view of an electronic candle according to an embodiment of the present disclosure.

FIG. 2 is a structural schematic view of the electronic candle according to an embodiment of the present disclosure from another perspective.

FIG. 3 is a partially structural schematic view of the electronic candle according to an embodiment of the present disclosure.

FIG. 4 is an enlarged view of portion A shown in FIG. 3.

FIG. 5 is an enlarged view of portion B shown in FIG. 3.

FIG. 6 is an exploded view of the electronic candle according to an embodiment of the present disclosure.

FIG. 7 is an exploded view of the electronic candle according to an embodiment of the present disclosure from another perspective.

FIG. 8 is a sectional view of the electronic candle according to an embodiment of the present disclosure.

FIG. 9 is an enlarged view of portion C shown in FIG. 8.

FIG. 10 is a partially exploded sectional view of the electronic candle according to an embodiment of the present disclosure.

FIG. 11 is an enlarged view of portion D shown in FIG. 10.

FIG. 12 is a schematic structural view of the candle tube according to an embodiment of the present disclosure.

### REFERENCE NUMERALS IN THE DRAWINGS

1, inner housing; 11, outer wall; 12, limiting part; 120, stepped portion; 1201, first section; 1202, second section; 121, limiting surface; 122, positioning portion; 1221, first slot; 1222, second slot; 1223, protrusion; 13, accommodating cavity; 14, first end; 15, second end; 151, second inner wall; 152, first step surface; 2, light element; 21, positive wire; 22, negative wire; 23, lamp bead; 24, illumination zone; 3, candle tube; 31, third end; 311, end surface; 3111, receiving recess; 31111, recess bottom; 31112, through hole; 31113, supporting surface; 32, fourth end; 321, first inner wall; 3211, limiting groove; 4, electronic assembly; 41, PCBA; 42, lamp head; 43, battery case; 431, case body; 4311, receiving chamber; 43111, opening of the receiving chamber; 4312, first side wall; 43121, upper side wall; 43122, lower side wall; 4313, accommodating groove; 4314, switch; 4315, flange; 432, battery; 433, cover; 4331, groove; 4332, bottom surface of the cover; 4333, second side wall; 4334, bottom wall; 4335, recessed groove; 44, waterproof member; 45, waterproof ring; 451, sealing layer.

### DETAILED DESCRIPTION

In order to enable those skilled in the art to better understand the technical solutions of the present disclosure, the technical solutions in the embodiments of the present disclosure will be clearly and completely described below with reference to the accompanying drawings.

Unless otherwise defined, all technical and scientific terms used herein have the same meaning as commonly understood by those skilled in the art to which this disclosure belongs. The terms used in the description of the application herein are intended for describing particular embodiments only and are not intended to limit the present disclosure. In the description, claims, and the above drawings of the present disclosure, the terms “comprising” and “having”, as well as their variants, are intended to convey a non exclusive inclusion. The terms “first”, “second”, etc., as used herein, are intended to distinguish between different objects, rather than to describe a particular order.

Reference to “embodiments” herein implies that a particular feature, structure, or characteristic described in connection with an embodiment may be included in at least one embodiment of the present disclosure. The appearance of the phrase at various places in the specification does not necessarily refer to the same embodiment, nor is it a separate or alternative embodiment that is mutually exclusive of other embodiments. One skilled in the art would explicitly and implicitly understand that the embodiments described herein can be combined with other embodiments.

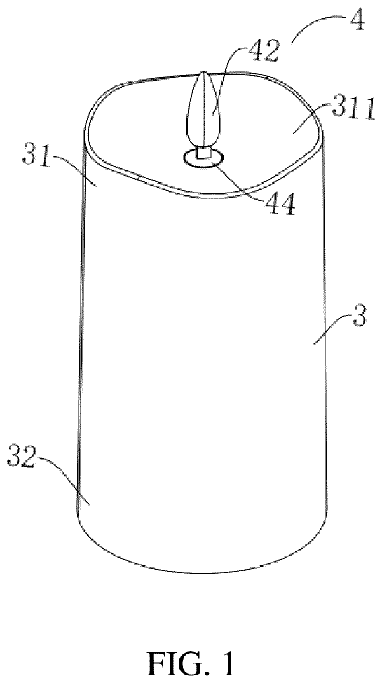

To solve the above technical problem, as shown in FIGS. 1, 2, 6, and 7, an embodiment of the present disclosure provides an electronic candle, including an inner housing 1 and a light element 2 disposed on the inner housing 1. In some embodiments, the light element 2 can also be disposed on an outer surface and/or a top surface of the inner housing 1. The electronic candle includes a candle tube 3 which is light-transmissive and non-transparent, the candle tube 3 is sleeved outside the inner housing 1. The candle tube 3 can be made of a translucent plastic material, and the light element 2 is positioned between the inner housing 1 and the candle tube 3. The electronic candle further includes an electronic assembly 4, the electronic assembly 4 includes a printed circuit board assembly (PCBA) 41 and a lamp head 42, at least a portion of the PCBA 41 is arranged within the inner housing 1, and the PCBA 41 is electrically connected to the light element 2 and the lamp head 42 to control light-emitting states of the light element 2 and the lamp head 42. The lamp head 42 extends through the candle tube 3 and is connected to the PCBA 41, the candle tube 3 simulates a shape of a real candle, and the lamp head 42 simulates a shape of a flame of the real candle. When the light element 2 is not illuminated, the light element 2 cannot be seen from outside the candle tube 3; when the light element 2 is illuminated, light emitted from the light element 2 passes through the candle tube 3 to form an illumination zone 24, and at this time, only the illumination zone 24 is visible to a user, which improves a visual appearance of the electronic candle. The light from the light element 2 can be diffused by the candle tube 3, which increases an area of the illumination zone 24. In addition, the light passing through the candle tube 3 can generate a hazy and soft visual effect.

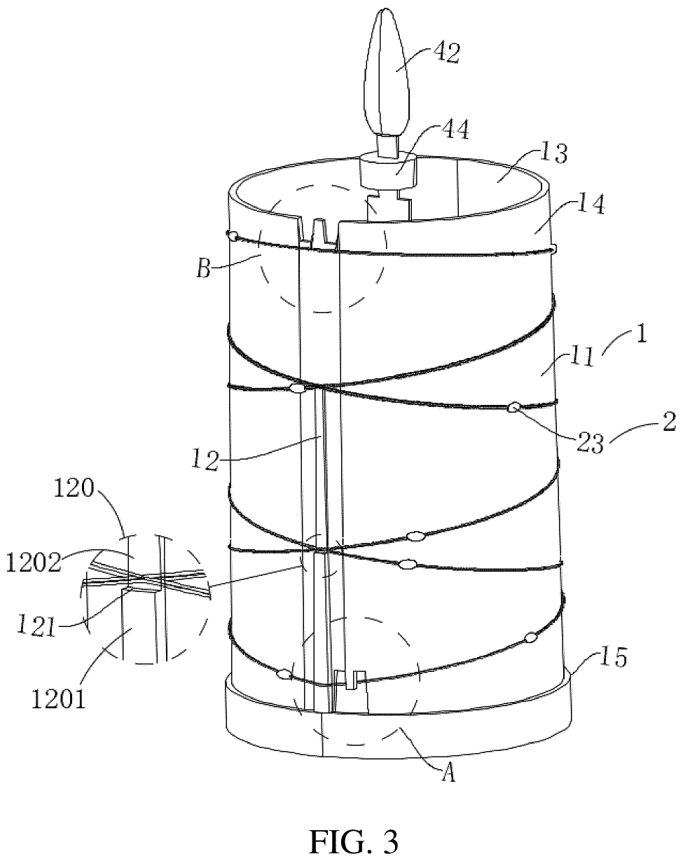

In an embodiment of the present disclosure, as shown in FIG. 3, the light element 2 is flexible and is capable of bending to form curved or irregular shapes. The inner housing 1 is configured as a tubular structure and includes an outer wall 11 extending circumferentially, and the light element 2 is wound around the outer wall 11 along an axial direction of the inner housing 1. The light element 2 can be wound on the outer wall 11 in a cross layout or a spiral layout, such that the light emitted from the light element 2 can be transmitted as uniformly as possible, and the visual appearance is further enhanced.

In an embodiment of the present disclosure, as shown in FIG. 3, the inner housing 1 includes at least one limiting part 12. The at least one limiting part 12 is disposed on the outer wall 11 of the inner housing 1, each limiting part 12 includes a limiting surface 121 facing upward, and at least a portion of the light element 2 is supported on the limiting surface 121, such that the light element 2 can be prevented from sliding downward. The limiting part 12 can be configured as a projection, and a plurality of projections can be arranged along a height direction of the inner housing 1, a top of each projection forms a horizontal or inclined limiting surface 121. The limiting part 12 may also be configured as a groove 4331, a wall of the groove 4331 forms the limiting surface 121, and a portion of an edge of the light element 2 is embedded in the groove 4331 and retained by the limiting surface 121.

In an embodiment of the present disclosure, as shown in FIG. 3, the limiting part 12 is configured as a strip-shaped protruding rib, and the protruding rib extends in the height direction of the inner housing 1. The inner housing 1 may include a plurality of the protruding ribs, and the plurality of the protruding ribs are distributed in a circumferential direction of the inner housing 1. Each protruding rib includes a stepped portion 120, and the limiting surface 121 is formed at the stepped portion 120. To be specific, the stepped portion 120 comprises a first section 1201 and a second section 1202 that is positioned above the first section 1201. The thickness of the first section 1201 is thicker than that of the second section 1202, and the limiting surface 121 is located between the first section 1201 and the second section 1202. A quantity of the limiting surfaces 121 can be determined based on a height at which the light element 2 is wound, and may be one or more. When the light element 2 is wound in multiple layers, each limiting surface 121 can support and fix one layer of the light element 2, so that the winding of the light element 2 is stratified and stable. In the present disclosure, the light element 2 can be wound on the outer wall 11 in a cross layout, and intersections of the cross layout of the light element 2 can be supported on the limiting surfaces 121.

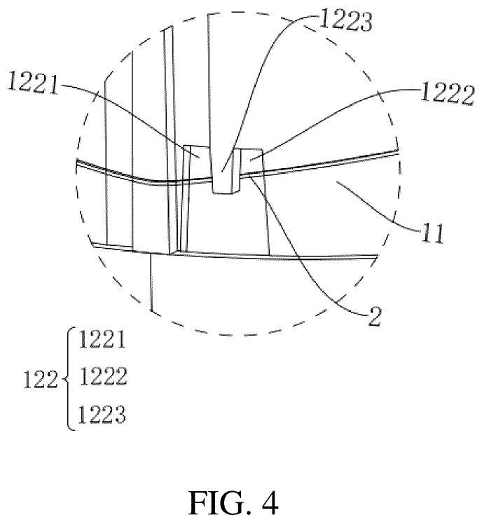

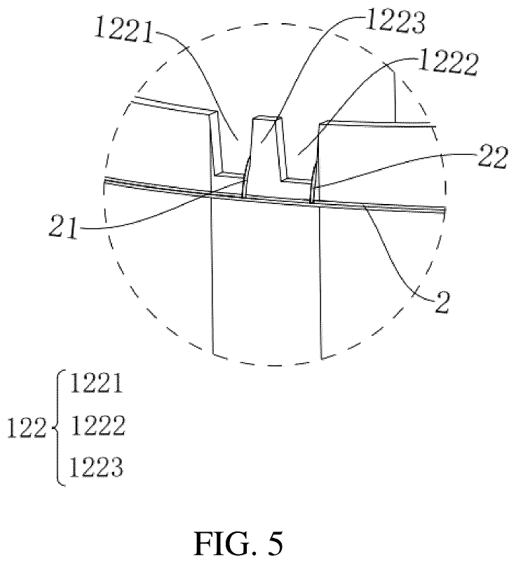

In an embodiment of the present disclosure, as shown in FIG. 3, FIG. 4, and FIG. 5, the inner housing 1 further includes at least one positioning portion 122. The positioning portion 122 includes a first slot 1221 and a second slot 1222, the first slot 1221 and the second slot 1222 are formed through an outer wall 11 of the inner housing 1. The first slot 1221 and the second slot 1222 extend through both an inner side and an outer side of the inner housing 1. The first slot 1221 and the second slot 1222 may be communicated with each other, and a protrusion 1223 is formed between the first slot 1221 and the second slot 1222. One end of the light element 2 enters the first slot 1221, is wound around the protrusion 1223, and then passes out through the second slot 1222, such that the light element 2 can be fixed on the protrusion 1223. The positioning portion 122 may be provided at an initial position and a terminal position of a winding path of the light element 2 to ensure that the initial position and the terminal position of the light element 2 can be fixed, preventing the light element 2 from loosening or falling off due to vibration or external force during use.

In an embodiment of the present disclosure, as shown in FIG. 3 and FIG. 5, the inner housing 1 further includes a first end 14 and a second end 15 positioned below the first end 14, the first end has an opening. One of the at least one positioning portions 122 is located adjacent to the opening of the first end 14, the first slot 1221 and the second slot 1222 of the one of the at least one positioning portion 122 are spaced apart and in communication with the opening of the first end 14. The light element 2 includes a positive wire 21 and a negative wire 22, the positive wire 21 passes through the first slot 1221 of the one of the at least one positioning portion 122, and the negative wire 22 passes through the second slot 1222 of the one of the at least one positioning portion 122, and both the positive wire 21 and the negative wire 22 are electrically connected to the PCBA 41. In another embodiment, the positive wire 21 and the negative wire 22 can also pass through the first slot 1221 and the second slot 1222 of any one of the at least one positioning portions 122, as long as the positive wire 21 and the negative wire 22 can be connected to the PCBA 41.

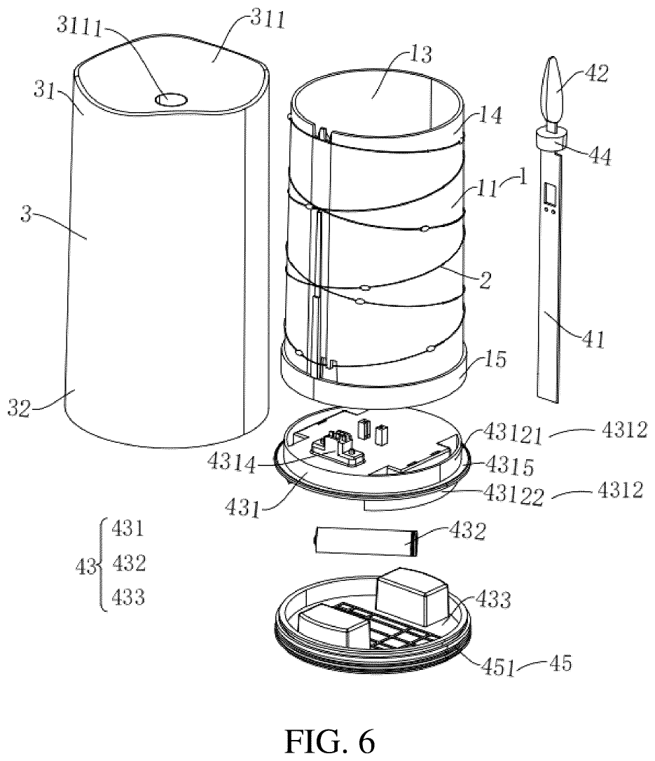

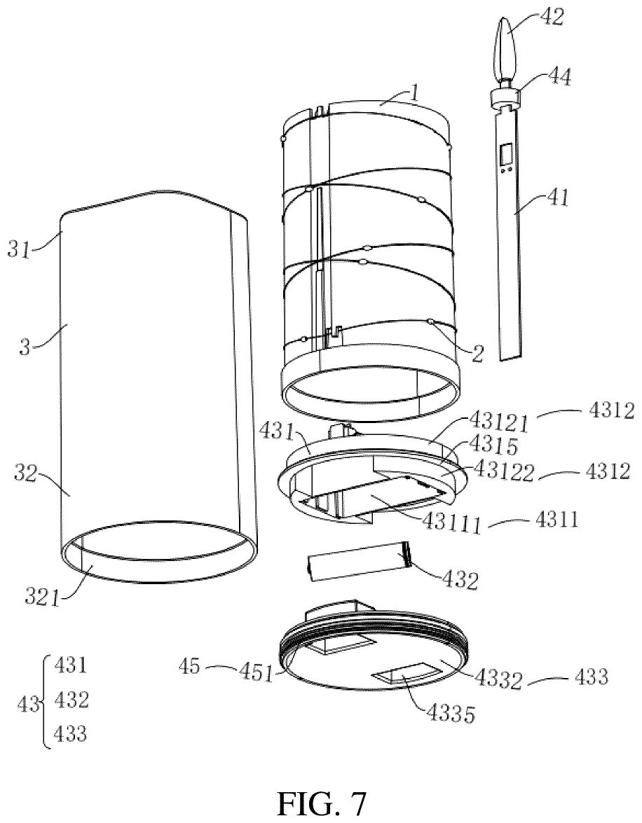

In an embodiment of the present disclosure, as shown in FIG. 6 and FIG. 7, the inner housing 1 can be formed as a tubular structure, and an accommodating cavity 13 is defined inside the inner housing 1, the PCBA 41 is inserted in the accommodating cavity 13, the inner housing 1 includes a first end 14 and a second end 15, the second end 15 has an opening communicating with the accommodating cavity 13. The second end 15 is open and communicates with the accommodating cavity 13. The first end 14 may be open to facilitate the lamp head 42 being connected to the PCBA 41. Alternatively, the first end 14 may be closed, and the lamp head 42 penetrates through the first end 14. The candle tube 3 can also be formed as a tubular structure, and the candle tube 3 is sleeved outside the inner housing 1 with a small gap between the candle tube 3 and the inner housing 1, such that the light element 2 and the light emitted by the light element 2 can be as close as possible to the candle tube 3. The candle tube 3 includes a third end 31 and a fourth end 32. The third end 31 is closed to form an end surface 311, and the fourth end 32 has an opening. The lamp head 42 extends through the end surface 311 of the third end 31 and is electrically connected to the PCBA 41. The electronic assembly 4 further includes a battery case 43. The second end 15 of the inner housing 1 is flush or substantially flush with the fourth end 32 of the candle tube 3, and both the third end 31 and the fourth end 32 are open. The battery case 43 seals the second end 15 of the inner housing 1 and the fourth end 32 of the candle tube 3. The PCBA 41 includes a fifth end and a sixth end. The fifth end is connected to the lamp head 42, and the sixth end is on the battery case 43 and electrically connected to the battery case 43. The battery case 43 supplies power to the PCBA 41.

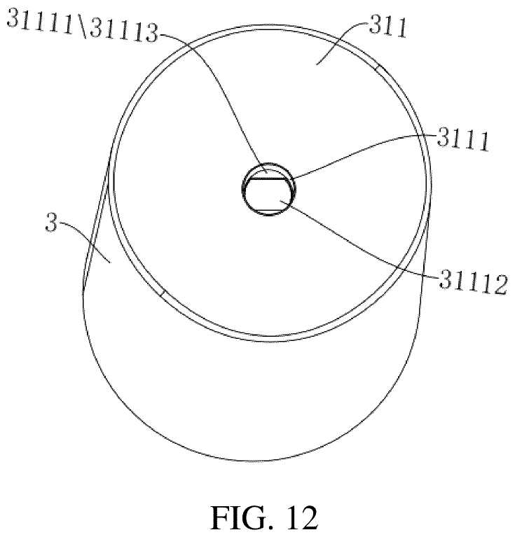

In an embodiment, with reference to FIG. 1 and FIG. 12, the end surface 311 of the third end 31 of the candle tube 3 defines an upward-facing receiving recess 3111. A through hole 31112 is defined in a recess bottom 31111 of the receiving recess 3111. The lamp head 42 includes a shank portion and a head portion. The shank portion extends through the through hole 31112, and the head portion is exposed outside the candle tube 3. The electronic assembly 4 further includes a waterproof member 44. The waterproof member 44 is disposed in the receiving recess 3111 and is in an interference fit with both the receiving recess 3111 and the shank portion of the lamp head 42. The waterproof member 44 may be made of an elastically deformable material, such as silicone or rubber. The waterproof member 44 is compressed between the shank portion of the lamp head 42 and the receiving recess 3111 to seal the through hole 31112. When the electronic candle is used outdoors, the waterproof member 44 prevents rainwater from entering the candle tube 3 through the through hole 31112.

In an embodiment of the present disclosure, as shown in FIG. 12, a sectional area of the through hole 31112 is smaller than an area of the recess bottom 31111 of the receiving recess 3111, and a supporting surface 31113 is formed on the recess bottom 31111, the supporting surface 31113 can support the waterproof member 44, such that the waterproof member 44 can be stably placed on the recess bottom 31111 and remains in position when compressed.

In an embodiment of the present disclosure, as shown in FIG. 6 and FIG. 7, the battery case 43 includes a case body 431, a battery 432, and a cover 433. The case body 431 defines a receiving chamber 4311 having a downward opening. In an embodiment, the battery 432 is received in the receiving chamber 4311. The case body 431 is provided with an electrode tab electrically connected to the battery 432. The PCBA 41 is electrically connected to the electrode tab via wires. The cover 433 is detachably mounted on the opening 43111 of the receiving chamber 43 11, so as to facilitate installation and replacement of the battery 432. The case body 431 is provided with a switch 4314. The switch 4314 is electrically connected to the battery 432 and the PCBA 41. After the cover 433 is removed, the switch 4314 is exposed and can be manually operated by the user. When the user toggles the switch 4314, the light element 2 and the lamp head 42 can be turned on or turned off. The cover 433 is sealingly connected to the fourth end 32 of the candle tube 3, preventing rainwater from entering the electronic candle from the bottom when used outdoors.

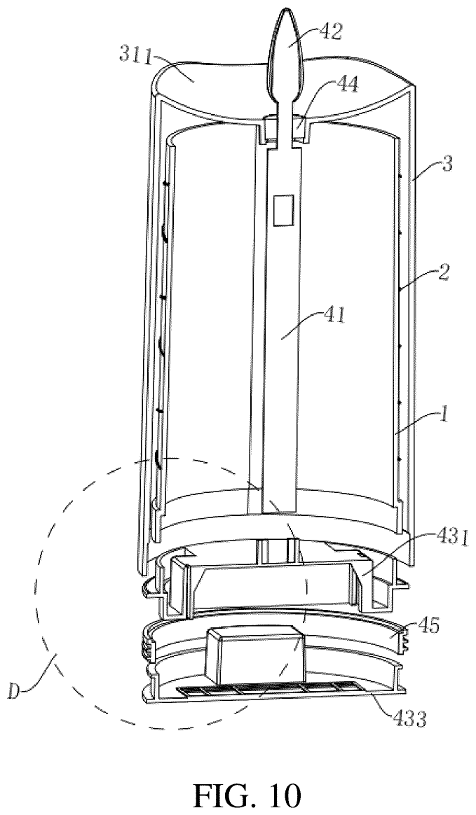

In an embodiment of the present disclosure, as shown in FIG. 6 and FIG. 10, the battery case further includes a waterproof ring 45, and the fourth end 32 of the candle tube 3 includes a first inner wall 321 extending circumferentially. The cover 433 includes a bottom wall 4334 and a second side wall 4333 extending upward from an edge of the bottom wall 4334. The groove 4331 is annular and defined in the second side wall 4333 facing the first inner wall 321, at least a portion of the waterproof ring 45 is received in the groove 4331. When the cover 433 is assembled with the fourth end 32 of the candle tube 3, the second side wall 4333 and the first inner wall 321 together compress the waterproof ring 45, and the waterproof ring 45 is positioned between the second side wall 4333 and the first inner wall 321, such that the second side wall 4333 can be sealingly connected to the first inner wall 321. As a result, the waterproof ring 45 can sealingly connect the cover 433 and the first inner wall 321.

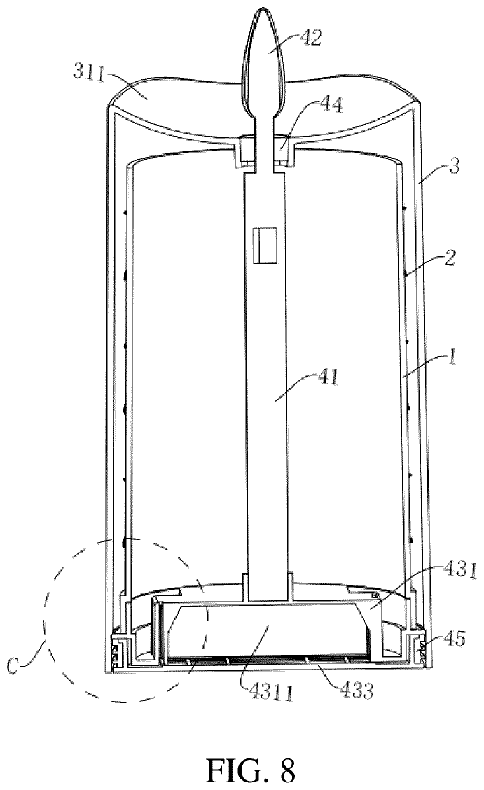

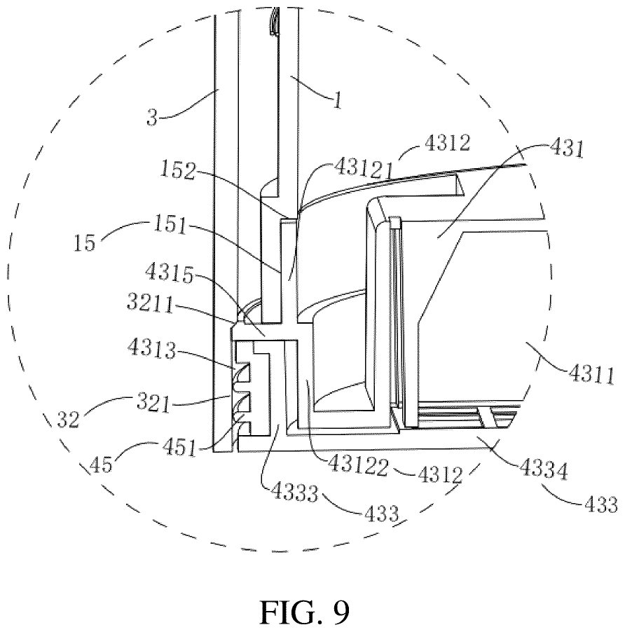

In an embodiment of the present disclosure, as shown in FIG. 8 and FIG. 9, the waterproof ring 45 includes a plurality of sealing layers extending laterally. The plurality of sealing layers 451 are arranged at intervals, and each of the plurality of sealing layers 451 is sealingly connected to the first inner wall 321, in this way, sealing performance of the electronic candle can be enhanced.

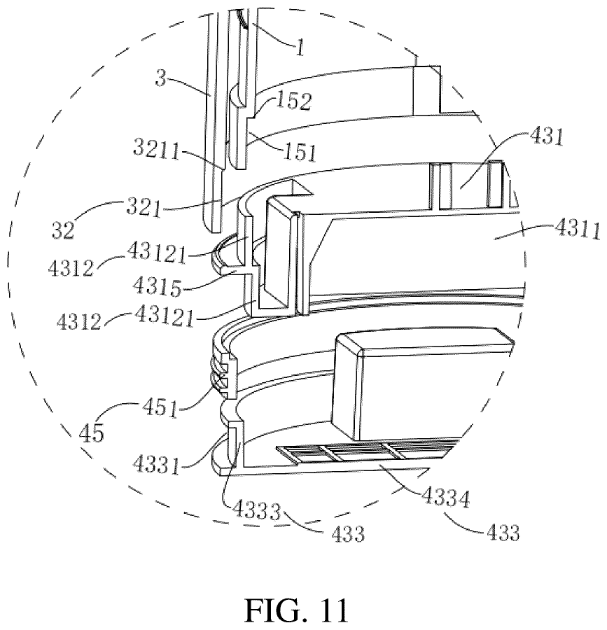

In an embodiment of the present disclosure, as shown in FIG. 9 and FIG. 11, the case body 431 includes a first side wall 4312, the second end 15 of the inner housing 1 extends outward to form a second inner wall 151 along the circumferential direction. At a bending portion of the inner housing 1 where the second inner wall 151 extends from the second end 15, a first step surface 152 facing downwardly is formed. The first side wall 4312 includes an outer side surface and a top surface. The outer side surface abuts against the second inner wall 151, and the top surface abuts against the first step surface 152. In this way, a secure engagement between the case body 431 and the inner housing 1 is achieved, preventing the case body 431 from becoming loose or displaced during use.

In an embodiment of the present disclosure, as shown in FIG. 9 and FIG. 11, a flange 4315 extending laterally is formed at or near a middle portion of the first side wall 4312. A limiting recess 3211 is defined in the first inner wall 321 of the candle tube 3. The flange 4315 abuts against the limiting recess 3211 to achieve a tight fit between the case body 431 and the candle tube 3, preventing the case body 431 and the inner housing 1 from moving upward relative to the candle tube 3.

In an embodiment of the present disclosure, as shown in FIG. 9, the flange 4315, the first side wall 4312 and the first inner wall 321 together define an accommodating groove 4313 that has an opening facing downwardly. The first side wall 43 12 includes an upper side wall 43121 located above the flange 4315 and a lower side wall 43122 located below the flange 4315. The upper side wall 43121 abuts against both the second inner wall 151 and the first step surface 152. The accommodating groove 4313 is defined among the lower side wall 43122, the flange 4315, and the first inner wall 321. The second side wall 4333 of the cover 433 and the waterproof ring 45 are disposed in the accommodating groove 4313. The accommodating groove 4313 enhances a connection strength between the cover 433 and the candle tube 3, and facilitates the user in installing and removing the cover 433.

In an embodiment of the present disclosure, with reference to FIG. 7, the bottom surface 4332 of the cover 433 defines at least one recessed groove 4335. In an embodiment, the bottom surface 4332 has two recessed grooves 4335 spaced apart from each other. The user can press the two recessed grooves 4335 with their fingers to open the cover 433.

In an embodiment of the present disclosure, as shown in FIG. 3, the light element 2 can be a light string or a flexible light board. The flexible light board may be configured as a strip-shaped light board, with at least one lamp bead 23 arranged on one side of the light board, and the other side of the light board is attached to the inner housing 1.

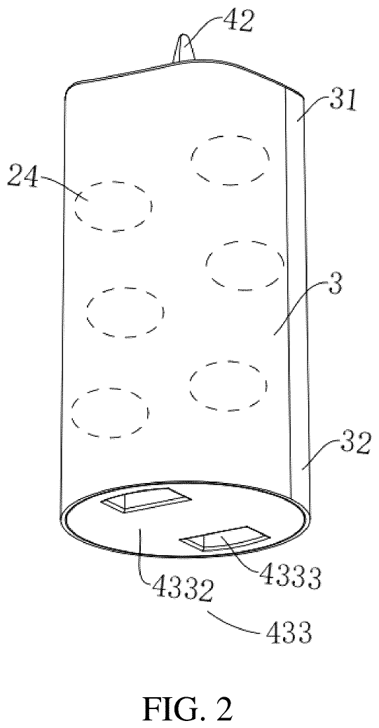

In an embodiment of the present disclosure, as shown in FIG. 2, the light element 2 includes a plurality of lamp beads 23, light emitted from each of the plurality of lamp beads 23 passes through the candle tube 3 and forms a spot shaped illumination zone 24 on the candle tube 3, in this way, when viewed from a distance, the user perceives an effect as if stars are suspended on the candle tube 3, and the aesthetic of the electronic candle is further improved.

In an embodiment of the present disclosure, as shown in FIG. 3, both the lamp head 42 and the light element include the plurality of lamp beads 23, and each of the plurality of lamp beads 23 flickers according to a predetermined frequency to perform a breathing light effect. As described herein, the term “flicker” refers to either a rapid on-and-off flashing or a gradual increase and decrease in brightness, both of which are used to simulate dynamic lighting effects. The breathing light effect of the lamp head 42 simulates a dynamic visual appearance of the real candle flame, making the visual effect of the lamp head 42 more realistic. The breathing frequency of the lamp head 42 can be coordinated with that of the light element 2, such as by being synchronized, so as to create a more harmonious and aesthetically pleasing lighting performance.

Obviously, the embodiments described above are only a part of the embodiments of the present disclosure, and not all of them. The accompanying drawings give some embodiments of the present disclosure, but do not limit the patentable scope of the disclosure, which may be realized in many different forms. Rather, these embodiments are provided for the purpose of providing a more thorough and comprehensive understanding of the present disclosure. Although the present disclosure has been described in detail with reference to the foregoing embodiments, it is still possible for a person skilled in the art to modify the technical solutions recorded in the foregoing specific embodiments or to make equivalent substitutions for some of the technical features therein. Any equivalent structure made by utilizing the contents of the specification and the accompanying drawings of the present disclosure, directly or indirectly applied in other related technical fields, are all the same within the scope of the patent protection of the present disclosure.

What is claimed is:

1. An electronic candle, comprising:
an inner housing;
a light element, disposed on the inner housing;
a candle tube, sleeved outside the inner housing, wherein the candle tube is light-transmissive and non-transparent, the lighting element emits light that passes through the candle tube; and
an electronic assembly, comprising a printed circuit board assembly (PCBA) and a lamp head, wherein at least a portion of the PCBA is arranged within the inner housing, the PCBA is electrically connected to both the light element and the lamp head, and the lamp head extends through the candle tube.

2. The electronic candle according to claim 1, wherein the inner housing comprises an outer wall, and the light element is flexible and wound around the outer wall.

3. The electronic candle according to claim 2, wherein the inner housing comprises at least one limiting part, the at least one limiting part is located on the outer wall, the at least one limiting part comprises at least one limiting surface facing upward, and at least a portion of the light element is supported on the at least one limiting surface.

4. The electronic candle according to claim 3, wherein the at least one limiting part is a protruding rib extending in a height direction of the inner housing, the protruding rib comprises a stepped portion, the stepped portion comprises a first section and a second section located higher than the first section, and the limiting surface is located between the first section and the second section.

5. The electronic candle according to claim 2, wherein the inner housing comprises at least one positioning portion, each of the at least one positioning portion comprises a first slot and a second slot, the first slot and the second slot are defined in the outer wall, a protrusion is formed between the first slot and the second slot, the first slot and the second slot are communicated with each other, the light element passes through the first slot and the second slot and is retained by the protrusion.

6. The electronic candle according to claim 5, wherein the light element comprises a positive wire and a negative wire, the positive wire passes through the first slot of one of the at least one positioning portion, and the negative wire passes through the second slot of the one of the at least one positioning portion, both the positive wire and the negative wire are electrically connected to the PCBA.

7. The electronic candle according to claim 1,
wherein the inner housing has an accommodating cavity, the PCBA is inserted in the accommodating cavity, the inner housing comprises a first end and a second end, the second end has an opening communicating with the accommodating cavity;
wherein the candle tube comprises a third end and a fourth end, the third end is closed to form an end surface, the fourth end has an opening, the lamp head extends through the end surface and is electrically connected to the PCBA;
wherein the electronic assembly comprises a battery case, the battery case seals the second end of the inner housing and the fourth end of the candle tube, the PCBA is electrically connected to the battery case.

8. The electronic candle according to claim 7,
wherein a receiving recess is defined in the end surface, a through hole is defined in a recess bottom of the receiving recess, and the lamp head extends through the through hole;
wherein the electronic assembly further comprises a waterproof member, the waterproof member is arranged within the receiving recess, the waterproof member is in an interference fit with the receiving recess, and the PCBA is in an interference fit with the waterproof member.

9. The electronic candle according to claim 8, wherein a sectional area of the through hole is smaller than an area of the recess bottom of the receiving recess, and a supporting surface is formed on the recess bottom of the receiving recess to support the waterproof member.

10. The electronic candle according to claim 7, wherein the battery case comprises:
a case body, defining a receiving chamber, the receiving chamber having a downward opening;
a battery, being received in the receiving chamber;
a cover, being detachably mounted on the opening of the receiving chamber, wherein the cover is sealingly connected with the fourth end of the candle tube.

11. The electronic candle according to claim 10, wherein the battery case further comprises a waterproof ring, the fourth end comprises a first inner wall, a groove is defined in a side of the cover facing the first inner wall, at least a portion of the waterproof ring is received in the groove, and the waterproof ring sealingly connects the cover with the first inner wall.

12. The electronic candle according to claim 11, wherein the waterproof ring comprises a plurality of sealing layers, each of the plurality of sealing layers is sealingly connected to the first inner wall.

13. The electronic candle according to claim 10, wherein the case body comprises a first side wall, the second end of the inner housing extends outward to form a second inner wall and a first step surface, the first side wall abuts against the second inner wall and the first step surface.

14. The electronic candle according to claim 13, wherein a flange is formed extending around on the first side wall, and a limiting recess is defined in the first inner wall, and the flange is inserted into the limiting groove to abut against a wall of the limiting groove.

15. The electronic candle according to claim 14, wherein the flange, the first side wall, and the first inner wall together define an accommodating groove that has an opening facing downwardly, and the cover is mounted in the accommodating groove.

16. The electronic candle according to claim 10, wherein a recessed groove is defined in a bottom surface of the cover.

17. The electronic candle according to claim 1, wherein the light element is a light string or a flexible light panel.

18. The electronic candle according to claim 1, wherein the light element comprises a plurality of lamp beads, and light emitted from each of the plurality of light beads passes through the candle tube and form a spot shaped illumination zone on the candle tube.

19. The electronic candle according to claim 1, wherein the lamp head comprises a plurality of lamp beads, and each of the plurality of lamp beads flickers according to a predetermined frequency to perform a breathing light effect.
